(19) United States
(12) Patent Application Publication
(10) Pub. No.: US 2026/0279249 A1
(43) Pub. Date: Sep. 17, 2026

(54) TRANSMISSION/RECEPTION CONTROL METHOD AND DISPLAY DRIVER USING SAME

(71) Applicant: LX SEMICON CO., LTD., Daejeon (KR)

(72) Inventors: Jeong Ho PARK, Daejeon (KR); Myung Yu KIM, Daejeon (KR); Jong Jin YANG, Daejeon (KR)

(73) Assignee: LX SEMICON CO., LTD., Daejeon (KR)

(21) Appl. No.: 19/166,824

(22) PCT Filed: Mar. 21, 2024
(86) PCT No.: PCT/KR2024/003553

§ 371 Date: Sep. 18, 2025

(30) Foreign Application Priority Data
Mar. 22, 2023 (KR) 10-2023-0037616
Mar. 20, 2024 (KR) 10-2024-0038727

(51) Int. Cl. G09G 3/20

(52) U.S. Cl. CPC G09G 3/2096; G09G 2330/021; G09G 2340/0435

(57) ABSTRACT

The present disclosure relates to a transmission and reception control method and a display driver using the same. The display driver includes: an interrupt signal generation part configured to transmit an interrupt signal to a host processor through an interrupt signal line within a vertical blank period in each of a first mode and a second mode; a reception part configured to receive data of an image signal from the host processor through a data lane together with a synchronization signal in the first mode, and to receive the data of the image signal through the data lane in the second mode; and a display control part configured to generate a display timing signal based on the synchronization signal received from the host processor and outputs the data of the image signal in the first mode, and to generate the display timing signal and outputs the data of the image signal in the second mode.

### TECHNICAL FIELD

The present disclosure relates to a transmission/reception control method and a display driver using same.

### BACKGROUND ART

There are known various display devices such as liquid crystal devices (LCDs), electroluminescence displays (ELDs) such as organic light-emitting diode (OELD) displays, field emission displays (FEDs), and plasma display panels (PDPs). Such display devices may visually reproduce, on a display panel, image signals received from a host system through a high-speed interface.

Recently, in order to reduce power consumption of a display device, a frame frequency or a refresh rate of an image signal may be lowered under certain conditions. When the refresh rate is lowered, an asynchronization problem between a transmission-side circuit and a reception-side circuit of a high-speed interface may become serious. This may result in deterioration of image quality such as missing frames in an image reproduced on a display panel.

### DISCLOSURE

### Technical Problem

The present disclosure provides a transmission and reception control method capable of solving an asynchronization problem between a host system and a display driver when a refresh rate is lowered in a high-speed interface that supports a variable refresh rate, and a display driver using the same.

### Technical Solution

A transmission and reception control method according to an embodiment of the present disclosure includes: a step in which in a first mode, a transmission device waits in a non-driving state during a vertical blank period and a reception device transmits an interrupt signal to the transmission device within the vertical blank period; a step in which in the first mode, the transmission device wakes up and is synchronized with the reception device when the interrupt signal is detected, and transmits data of an image signal to the reception device together with a synchronization signal; and a step in which in a second mode, the transmission device transmits the data of the image signal to the reception device without the synchronization signal and a synchronization signal is generated in the reception device.

The transmission device may be synchronized with the reception device in a clock and a horizontal period count based on a value obtained by counting the interrupt signal in the first mode.

When a refresh rate of the image signal is lowered, the vertical blank period may be extended, and the transmission device waits in the non-driving state within the extended vertical blank period until the interrupt signal is detected.

The interrupt signal may have a pulse width from 90% to 110% of 1 frame period or comprises an impulse.

The first mode may be a video mode of a mobile industry processor interface (MIPI). The second mode may be a command mode of the MIPI. The transmission device may include one of a system on chip (SoC), an application processor (AP), and a graphics processing unit (GPU). The reception device mayh include a display driver that outputs the data of the image signal and outputs a display timing signal.

A display driver according to an embodiment of the present disclosure includes: an interrupt signal generation part configured to transmit an interrupt signal to a host processor through an interrupt signal line within a vertical blank period in each of a first mode and a second mode; a reception part configured to receive data of an image signal from the host processor through a data lane together with a synchronization signal in the first mode, and to receive the data of the image signal through the data lane without the synchronization signal in the second mode; and a display control part configured to generate a display timing signal based on the synchronization signal received from the host processor and outputs the data of the image signal in the first mode, and to generate the display timing signal based on an internally generated synchronization signal and outputs the data of the image signal in the second mode.

### Advantageous Effects

According to an embodiment of the present disclosure, a transmission and reception control method may prevent an asynchronization problem between a display driver and a host processor by transmitting an interrupt signal to a host processor in a non-driving state during a vertical blank period.

According to an embodiment of the present disclosure, a host processor consumes no power by waiting in a non-driving state during a vertical blank period and a display driver transmits an interrupt signal to a host processor during the vertical blank period to induce wake-up of the host processor, thereby accurately synchronizing the host processor and the display driver.

According to an embodiment of the present disclosure, the display driver may improve power consumption by lowering a refresh rate in a preset condition in a video mode of MIPI DSI, and receive an image signal without missing the image signal.

The effects of the present disclosure are not limited to those mentioned above and other unmentioned effects will be clearly understood by those skilled in the art from the following description.

### DESCRIPTION OF DRAWINGS

FIG. 1 is a diagram showing a transmission and reception device according to an embodiment of the present disclosure;

FIG. 2 is a flow chart showing a transmission and reception control method according to an embodiment of the present disclosure;

FIG. 3 is a diagram showing input and output signals of a display driver in a command mode;

FIG. 4 is a diagram showing input and output signals of a display driver in a video mode;

FIGS. 5A and 5B are diagrams showing operations of a host processor and a display driver at a low refresh rate in a video mode;

FIG. 6 is a detailed diagram showing an operation in which a host processor transmits next frame data in response to an interrupt signal in a video mode;

FIG. 7 is a diagram showing an example in which a pulse width of an interrupt signal is longer than 1 frame period;

FIG. 8 is a diagram showing an example in which a pulse width of an interrupt signal is set to 1 frame period; and

FIG. 9 is a diagram showing a display device according to an embodiment of the present disclosure.

### BEST MODE

A transmission and reception control method according to an embodiment of the present disclosure includes: a step in which in a first mode, a transmission device waits in a non-driving state during a vertical blank period and a reception device transmits an interrupt signal to the transmission device within the vertical blank period; a step in which in the first mode, the transmission device wakes up and is synchronized with the reception device when the interrupt signal is detected, and transmits data of an image signal to the reception device together with a synchronization signal; and a step in which in a second mode, the transmission device transmits the data of the image signal to the reception device without the synchronization signal and a synchronization signal is generated in the reception device.

### Mode for Invention

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure. The present disclosure is only defined within the scope of the accompanying claims.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “comprising” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

Various embodiments of the present disclosure will be described below with reference to the accompanying drawings.

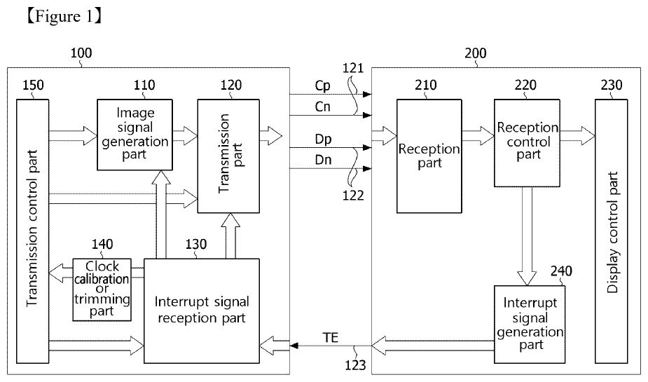

FIG. 1 is a diagram showing a transmission and reception device according to an embodiment of the present disclosure.

Referring to FIG. 1, the transmission and reception device includes a transmission device 100 and a reception device 200.

The transmission device 100 and the reception device 200 are connected to each other through a digital high-speed interface including a clock lane 121, a data lane 122, and an interrupt signal line 123, for example, a mobile industry processor interface (MIPI). The MIPI is a standard interface established by an MIPI Alliance. Although one data lane 122 is shown in FIG. 1, the present disclosure is not limited thereto. Two or more data lanes 122 through which image signals are respectively transmitted may be connected between the transmission device 100 and the reception device 200.

The transmission device 100 may transmit pixel data of an image signal and a clock signal to the reception device 200 through the digital high-speed interface. The clock signal may be transmitted to the reception device 200 through the clock lane 121 in the form of a differential signal including a positive polarity clock Cp and a negative polarity clock Cn. The input image signal may be transmitted to the reception device 200 through the data lane 122 in the form of a differential signal including positive polarity pixel data Dp and negative polarity pixel data Dn. An interrupt signal TE may be output from the reception device 200 in the form of a low-voltage digital signal or an impulse and transmitted to the transmission device 100. In the MIPI, the interrupt signal TE may be a tearing effect (TE), but is not limited thereto.

Hereinafter, the “transmission device” and the “reception device” will be referred to as a “host processor” and a “display driver,” respectively.

The host processor 100 may be one of a system on chip (SoC), an application processor (AP), and a graphics processing unit (GPU), which allow an image signal to be output by a host system such as a mobile device, a video phone, a smart watch, a watch phone, a wearable apparatus, an electronic notebook, an electronic book, a portable multimedia player (PMP), a personal digital assistant (PDA), an MP3 player, a mobile medical device, a desktop PC, a laptop PC, a netbook computer, a workstation, a navigation, a vehicle display device, a theater display device, a television, a wallpaper device, a signage device, a game device, a notebook computer, a monitor, a camera, a camcorder, and a home appliance, but is not limited thereto.

An MIPI display serial interface (DSI)-2 v2.0 may support a variable refresh rate (VRR) or an adaptive refresh panel (ARP) to improve power consumption of electronic devices to which the transmission and reception device is applied. The host processor 100 transmits frame data of an input image to the display driver 200 every frame period in a normal operation mode. 1 frame data includes pixel data for 1 frame written in all pixels of a screen or a display area of a display panel.

The host processor 100 may analyze the input image, lower a refresh rate in a still image or an always on display (AOD) screen where the input image does not change for a preset time, enter a low-power mode with almost no power consumption during an extended vertical blank period, and wait in the low-power mode until an interrupt signal is received. The AOD screen may be a portion of a pixel area of a display panel where preset information, for example, brief information such as remaining battery and time, is displayed when the host processor 100 waits in the low-power mode. In the low-power mode, the host processor 100 may consume little power by turning off power to other circuits except for circuits that respond to the interrupt signal.

1 (one) frame period may be divided into an active interval in which pixel data of an image signal exists and a vertical blank period in which there is no image signal between frame periods. As the refresh rate of pixels is lowered, the vertical blank period may become longer.

When an interrupt signal output from the display driver 200 is detected in the host processor 100, the host processor 100 may wake up and re-enter a normal driving mode. In the normal driving mode, the host processor 100 transmits next frame data of an image signal to the display driver 200 and then transmits frame data of an input image every frame period.

The host processor 100 includes a transmission control part 150, an image signal generation part 110, a transmission part 120, an interrupt signal reception part 130, and a clock calibration or trimming part 140. The transmission control part 150 may count a horizontal period with an internal clock (hereinafter, referred to as “first clock”) of the host processor 100, which is input through the clock calibration or trimming part 140, and determine an active interval in which the pixel data of an image signal exists in 1 frame period and a vertical blank period in which there is no image signal between frame periods. The transmission control part 150 may generate a synchronization signal that is synchronized with the pixel data of the image signal, for example, a vertical synchronization signal, and control the operation timing of each of the image signal generation part 110, the transmission part 120, and the interrupt signal reception part 130.

When the interrupt signal TE received from the display driver 200 is detected at an activation level, the interrupt signal reception part 130 counts the interrupt signal TE with the first clock generated from an internal oscillator of the host processor 100. The interrupt signal TE detected by the interrupt signal reception part 130 may be provided to the transmission control part 150, the image signal generation part 110, and the transmission part 120.

The clock calibration or trimming part 140 may trim or calibrate the pulse of the interrupt signal input through the interrupt signal reception part 130 and the first clock output from the internal oscillator, thereby synchronizing clocks between the host processor 100 and the display driver 200. The transmission control part 150 may count 1 horizontal period with a clock calibrated by the clock calibration or trimming part 140 and control 1 horizontal period of the host processor 100 to be equal to 1 horizontal period of the display driver 200.

The image signal generation part 110 generates the pixel data of the image signal under the control of the transmission control part 150. The image signal generation part 110 may scale the pixel data to match the resolution of the display panel, and convert the scaled data into data in a data transmission packet format satisfying the MIPI standard. The image signal generation part 110 may encode or pack synchronization signal data, for example, a vertical synchronization signal, into an image signal under the control of the transmission control part 150.

The transmission part 120 may convert the pixel data of the image signal and a clock into a differential signal under the control of the transmission control part 150, and transmit the differential signal to the display driver 200 through the clock lane 121 and the data lane 122. The image signal generation part 110 and the transmission part 120 may each include a memory for storing the pixel data of the image signal. The signal transmitted to the display driver 200 through the data lane 122 may include the pixel data of the image signal in a command mode, and may include the pixel data of the image signal and the synchronization signal data in a video mode.

The display driver 200 includes a reception part 210, a reception control part 220, a display control part 230, and an interrupt signal generation part 240.

The reception part 210 may receive the data of the image signal from the host processor 100 together with the synchronization signal through the data lane 122 in the video mode, and receive the data of the image signal from the host processor 100 without the synchronization signal through the data lane 122 in the command mode. The reception part 210 may receive a clock synchronized with the pixel data of the image signal through the clock lane 121, and receive the pixel data of the image signal and the synchronization signal through the data lane 122. The reception control part 220 may transmit the pixel data of the image signal and the synchronization signal to the display control part 230, and control the operation timings of the display control part 230 and the interrupt signal generation part 240 by using the synchronization signal.

The display control part 230 may convert the pixel data of the image signal input from the reception control part 220 into a data voltage, output the data voltage, and generate a display timing signal by using the synchronization signal. The display timing signal may include a source timing signal for controlling the operation timing of a data driver that outputs the data voltage, and a gate timing signal for controlling the operation timing of a gate driver that supplies a gate signal to gate lines of the display panel.

The interrupt signal generation part 240 may generate and output the interrupt signal TE under the control of the reception control part 220 in each of the video mode and the command mode. The interrupt signal TE may be transmitted to the host processor 100 through the interrupt signal line 123.

The high-speed interface of the present disclosure may support a command mode and a video mode published as a standard for the mobile industry processor interface (MIPI). The host processor 100 may transmit a mode signal with different data values in the command mode and the video mode to the display driver 200 through the data lane 122, thereby controlling the display driver 200 in the command mode or the video mode.

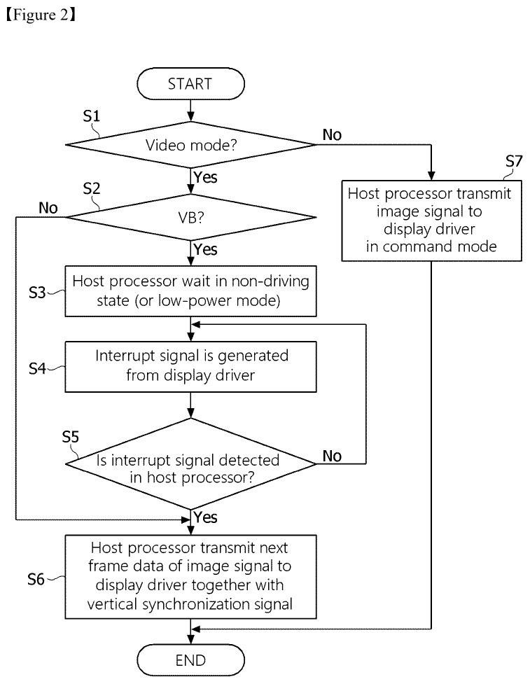

FIG. 2 is a flowchart showing a transmission and reception control method according to an embodiment of the present disclosure.

Referring to FIG. 2, the display driver 200 may receive frame data of an input image from the host processor 100 during an active interval of a frame period in the video mode (or first mode) (S1). The host processor 100 may transmit the frame data of the image signal to the display driver 200 in the command mode (or second mode) (S7).

In the video mode, the host processor 100 waits in a non-driving state (or low-power mode) until an interrupt signal TE is detected within a vertical blank period and outputs no image signal (S2 and S3). Accordingly, the display driver 200 does not receive the frame data of the input image during the vertical blank period in the video mode.

In the video mode, as the vertical blank period becomes longer, an asynchronous time difference between the host processor 100 and the display driver 200 may increase. In order to prevent such a problem, the display driver 200 transmits the interrupt signal TE or the impulse at an activation level to the host processor 100 within the vertical blank period of the video mode (S4).

When the interrupt signal or the impulse is detected in the video mode, the host processor 100 may wake up and be synchronized with the display driver 200, and transmit next frame data to the display driver 200 together with a vertical synchronization signal (S5 and S6).

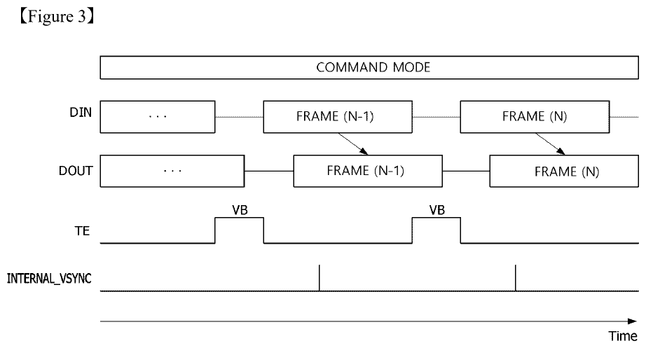

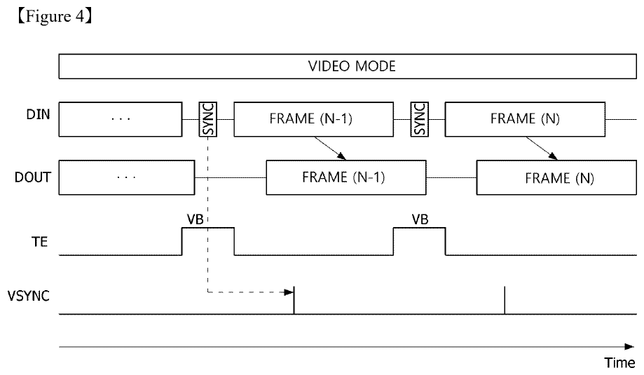

FIG. 3 is a diagram showing input and output signals of the display driver in the command mode. FIG. 4 is a diagram showing input/output signals of the display driver in the video mode. In FIGS. 3 and 4, “DIN” denotes an image signal input to the display driver 200, and “DOUT” denotes an image signal output from the display driver 200.

Referring to FIG. 3, in the command mode, the host processor 100 may transmit timing data, for example, pixel data of an image signal without a synchronization signal. In the command mode, since no timing data is received, the display driver 200 stores the pixel data of the image signal received from the host processor 100 in a frame memory in units of frames and generates a display timing signal.

In the command mode, the display driver 200 drives the pixels of the display panel by generating the display timing signal based on a clock (hereinafter, referred to as “second clock”) generated from an internal oscillator of the display driver 200. In the command mode, the display driver 200 may transmit the interrupt signal TE to the host processor 100. The pulse of the interrupt signal TE may be generated within a vertical blank period VB, in which there is no pixel data of the image signal between adjacent frame periods on a time axis, for example, an N-1th (N is a positive integer) frame period and an Nth frame period, and may be transmitted to the host processor 100. In the command mode, the host processor 100 may transmit next frame data of the image signal to the display driver 200 in response to the interrupt signal TE received from the display driver 200.

In FIG. 3, “INTERNAL_VSYNC” denotes a vertical synchronization signal generated in the display driver 200 in the command mode. The display driver 200 may generate the display timing signal based on the vertical synchronization signal INTERNAL_VSYNC generated by counting the second clock in the command mode and output a data voltage of pixel data.

Referring to FIG. 4, in the video mode, the host processor 100 may packet timing data, for example, at least one synchronization signal SYNC of a vertical synchronization signal, a horizontal synchronization signal, and a data enable signal, into the pixel data of the image signal, and transmit the pixel data to the display driver 200. In the video mode, since the display driver 200 may generate a display timing signal based on a timing signal received from the host processor, for example, synchronization signal data, the use of a frame memory is not essential.

In the video mode, since the display driver 200 receives the timing signal from the host processor 100, there is no need to transmit the interrupt signal TE for synchronization with the display driver 200; however, in an embodiment of the present disclosure, when the refresh rate of pixels is low in the video mode, the interrupt signal may be transmitted in order to prevent an asynchronization problem between the first clock of the host processor 100 and the second clock of the display driver 200.

In the video mode, when the refresh rate is lowered, for example, is lowered from a first refresh rate to a second refresh rate, a vertical blank period in which no image signal is input to the display driver 200 becomes longer. In the video mode, during an extended vertical blank period when the refresh rate is lowered, circuits other than an interrupt signal response circuit, for example, the interrupt signal reception part 130 waits in a low-power mode being a non-driving state in the host processor 100. Therefore, when the refresh rate is low in the video mode, an asynchronization problem may occur between the display driver 200 and the host processor 100, and as the vertical blank period becomes longer, an asynchronization error time may further increase. In order to prevent such a problem, the transmission and reception control method according to an embodiment of the present disclosure uses the interrupt signal TE in the video mode to synchronize the host processor 100, which is waiting in an unsynchronized state at a low refresh rate, with the display driver 200. The low refresh rate may be a refresh rate of a lower frequency than the highest refresh rate within a variable refresh rate range supported in the video mode, for example, a frequency of 1 Hz to 60 Hz when the highest refresh rate is 120 Hz, but is not limited thereto.

As shown in FIG. 4, there is no vertical synchronization signal INTERNAL_VSYNC generated in the display driver 200 in the video mode. The display driver 200 may generate a display timing signal by using a vertical synchronization signal VSYNC obtained by sampling the synchronization signal SYNC received from the host processor 100 in the video mode, and output a data voltage of pixel data.

When the resolution of the display panel is FHD (1920×1080), 1 frame period may be the sum of the total horizontal period of the vertical blank period and the active interval and 1111 horizontal periods. When the refresh rate is 60 Hz, 60 frame periods are allocated to 1 second. In such a case, 1 frame period is 1/60 second. The 60 frame periods are the sum of 66660 horizontal periods. When the refresh rate is lowered to 1 Hz, pixel data is written to pixels for 1 frame period corresponding to 1/60 second, and then no data is written to the pixels for the remaining 59 frame periods. Accordingly, when the refresh rate is 1 Hz, the vertical blank period extends to a time corresponding to 59 frame periods and is the sum of 65549 horizontal periods. When the refresh rate is lowered to 1 Hz, the pixels may be self-refreshed with a data voltage stored in a storage capacitor without being charged with a new data voltage during the vertical blank period.

The horizontal period within the vertical blank period may be counted as a clock independently generated in the host processor 100 and the display driver 200. An output variation may occur between an oscillator that generates the first clock in the host processor 100 and an oscillator that generates the second clock in the display driver 200. When a variation is assumed to be is ±5% in the oscillator of each of the host processor 100 and the display driver 200, a maximum error of 10% may occur between a horizontal period counted by the host processor 100 and a horizontal period counted by the display driver 200. In such a case, when the refresh rate is 1 Hz, the extended vertical blank period may be the time between 58994 horizontal periods and 72103 horizontal periods.

In order to prevent an increase in an error in a horizontal period count value between the host processor 100 and the display driver 200, the display driver 200 may transmit the interrupt signal TE to the host processor 100 during the vertical blank period.

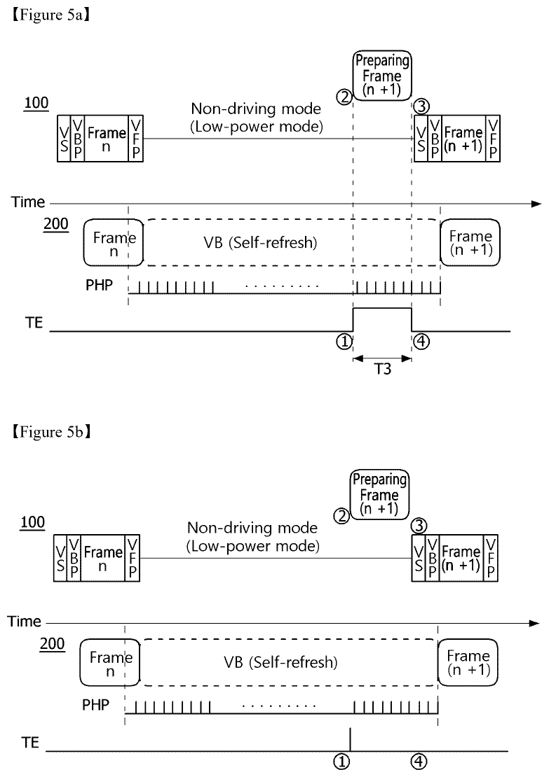

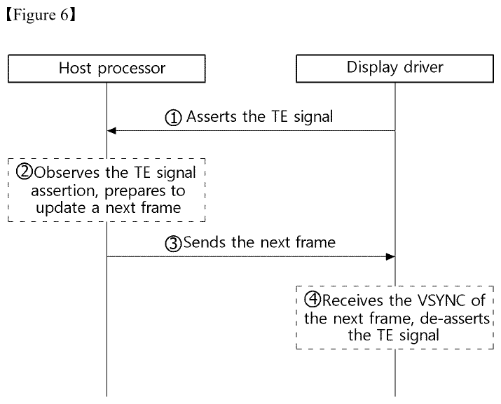

FIGS. 5A and 5B are diagrams showing the operations of the host processor and the display driver at a low refresh rate in the video mode. In FIGS. 5A and 5B, “Frame n” denotes nth frame data of an image signal and “Frame (n+1)” denotes n+1th frame data of the image signal. The interrupt signal TE shown in FIG. 5B is an example generated in the form of an impulse. FIG. 6 is a detailed diagram showing an operation in which the host processor transmits next frame data in response to the interrupt signal in the video mode.

Referring to FIGS. 5A, 5B, and 6, when the refresh rate is lowered in the video mode, the vertical blank period VB is extended. During the extended vertical blank period VB, the host processor 100 waits in a low-power mode with little power consumption, and the display driver 200 generates a panel charging signal PHP in order to control the self-refresh timing of pixels during the extended vertical blank period VB. Pulses of the panel charging signal PHP may be generated at a cycle of 1 horizontal period during the extended vertical blank period VB and the self-refresh timings of the pixels may be controlled to a cycle of 1 horizontal period. The gate driving part may output a gate pulse for self-refresh in response to a shift clock generated based on the panel charging signal PHP.

In the video mode, the display driver 200 outputs the pulse of the interrupt signal TE at an activation level during the preset interface signal period T3 within the extended vertical blank period VB at a low refresh rate \textcircled{1} Asserts the TE signal). Since the pulse of the interrupt signal TE is synchronized with a horizontal period count timing generated in the display driver 200, the horizontal period count timing generated in the host processor 100 in response to the pulse of the interrupt signal TE in the video mode may be synchronized with the horizontal period count timing of the display driver 200.

The host processor 100 wakes up in response to the pulse of the interrupt signal TE received in the video mode and prepares to transmit next frame data of the image signal, for example, n+1th frame data Frame(n+1) while counting 1 horizontal period \textcircled{2} Observes the TE signal assertion, prepares to update a next frame). The preparation process for transmitting the next frame data may include a step of generating the n+1th frame data Frame(n+1) of the image signal and scaling the n+1th frame data Frame(n+1) to match the resolution of the display panel, and a step of storing the scaled data in a memory. When the n+1th frame data is prepared in the video mode, the host processor 100 may transmit the n+1 th frame data Frame(n+1) to the display driver 200 together with the vertical synchronization signal VSYNC, and when the vertical synchronization signal VSYNC is detected in the received signal, the display driver 200 may invert the level of the interrupt signal TE to a deactivation level \textcircled{3} Sends the next frame and \textcircled{4} Receives the VSYNC of the next frame, de-asserts the TE signal). The vertical synchronization signal VSYNC may include vertical sync data VS, vertical back porch (VBP) data, and vertical front porch (VFP) data.

The pulse width or activation level duration of the interrupt signal TE needs to be appropriately limited in consideration of a clock variation error of each of the host processor 100 and the display driver 200. The pulse width of the interrupt signal TE may be set within 90% to 110% of 1 frame period. When the pulse width of the interrupt signal TE is too large, for example, greater than 110% of 1 frame period, the display driver 200 may count the horizontal period even when the host processor 100 transmits next frame data to the display driver 200, and as the time increases, a clock error time between the host processor 100 and the display driver 200 may increase.

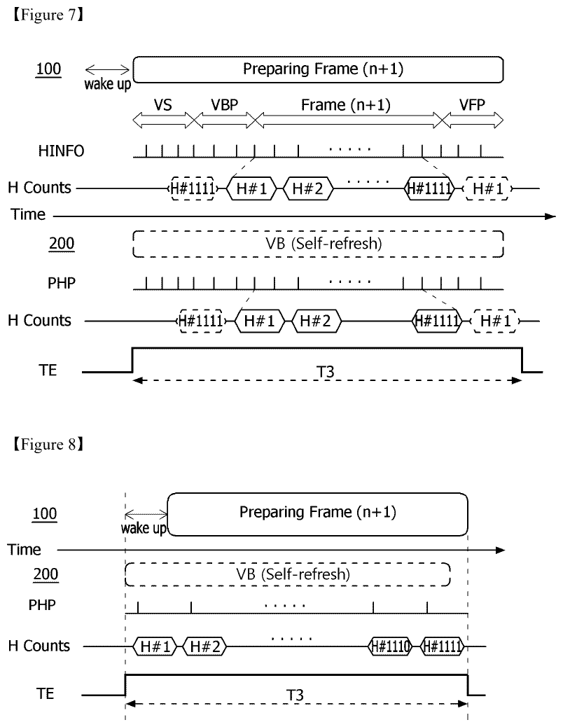

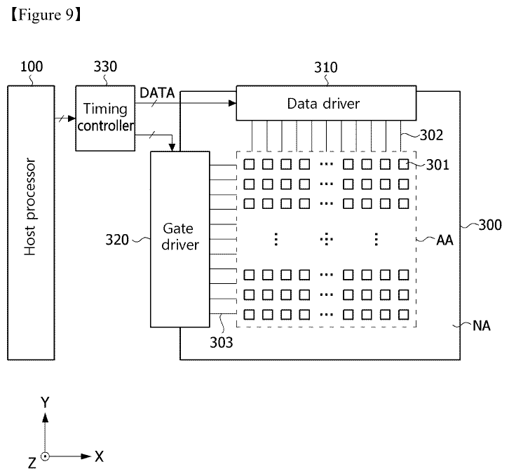

FIG. 7 is a diagram showing an example in which the pulse width of the interrupt signal is longer than 1 frame period. FIG. 8 is a diagram showing an example in which the pulse width of the interrupt signal is set to 1 frame period. In FIGS. 7 and 8, the horizontal period count H Counts is used to define the active interval and the vertical blank period every frame period by counting a clock in which a pulse is generated at a cycle of a horizontal period H #1 to H #1111.

FIG. 9 is a diagram showing a display device according to an embodiment of the present disclosure.

Referring to FIG. 9, the display device according to an embodiment of the present disclosure includes a display panel 300 and a display panel driving circuit for writing source data into pixels of the display panel 300.

A substrate of the display panel 300 may be a plastic substrate, a thin glass substrate, or a metal substrate, but is not limited thereto. The display panel 300 may be a panel with a rectangular structure having a length in the first direction X, a width in the second direction Y, and a thickness in the third direction Z, but is not limited thereto.

A display area AA of the display panel 300 includes a pixel array that displays an input image. The pixel array includes a plurality of data lines 302, a plurality of gate lines 303 crossing the data lines 302, and pixels 301 connected to the data lines 302 and the gate lines 303. Each of the pixels 301 may be divided into a red subpixel, a green subpixel, and a blue subpixel for color reproduction. Each of the pixels may further include a white subpixel.

Subpixels arranged in 1 pixel line may share the gate line 303, and subpixels arranged in the column direction Y along a data line direction may share the same data line 302. Pixel lines may be interpreted as horizontal lines. 1 horizontal period is the time obtained by dividing 1 frame period by the total number of pixel lines (or horizontal lines).

In an OLED display, each of the subpixels may include a light-emitting element such as an OLED. Each of the subpixels includes a pixel circuit for driving a light-emitting element. The pixel circuit may include a plurality of transistors and a storage capacitor.

As the transistor in the pixel circuit, an oxide thin film transistor (TFT) having a low leakage current may be applied. In such a case, in the oxide TFT, the power consumption of the display panel 100 may be reduced due to a low leakage current, and when a variable refresh rate is applied, a variation in the luminance of pixels is reduced at a low refresh rate, so that flicker visibility may be improved.

Pixel data of an input image may be written (or addressed) to subpixels arranged in 1 pixel line during 1 horizontal period. In such a case, a data voltage corresponding to the pixel data of the image signal may be charged in the storage capacitor of the pixel circuit within 1 horizontal period. During the extended vertical blank period with no input image, subpixels arranged in 1 pixel line may be self-refreshed with a data voltage of a previous frame charged in the storage capacitor in response to a gate pulse.

The display panel driving circuit writes the pixel data (or source data) of the input image to the pixels of the display panel 300 under the control of a timing controller 330. The display panel driving circuit includes a data driver 310 that converts the pixel data into a data voltage, and a gate driver 320.

The data driver 310 receives pixel data of an input image received as a digital signal from the timing controller 330 and outputs a data voltage. The data driver 310 may convert an input digital signal into a grayscale voltage (or gamma compensation voltage) by using a digital to analog converter (hereinafter, referred to as “DAC”), and output a data voltage. The data voltage of the pixel data may be output as a grayscale voltage corresponding to a grayscale value of the pixel data.

The data driver 310 may be integrated into an integrated circuit (IC). The timing controller 330 and the data driver 310 may be integrated together into an IC. The IC including the data driver 310 and the IC including the data driver 310 and the timing controller 330 may be interpreted as the display driver 200 described above.

The display panel driving circuit may further include a touch sensor driver for driving touch sensors. The touch sensor driver may be integrated into the display driver together with the data driver 310.

The display driver may be directly bonded to the substrate of the display panel 300 in a chip on glass (COG) or a chip on plastic (COP) process, and electrically connected to the display panel 300. The display driver may be mounted on a flexible film of a chip on film (COF), and the COF may be bonded to the display panel 300.

A circuit of the gate driver 320 may be disposed in a non-display area NA outside the display area AA in the display panel 300, or at least a portion of the circuit may be disposed in the display area AA. The gate driver 320 may be integrated into a separate gate driver IC and electrically connected to the gate lines 303 of the display panel 300.

The gate driver 320 sequentially outputs a gate pulse (or scan pulse) to the gate lines under the control of the timing controller 330. The gate driver 320 may shift the gate pulse by using a shift register to sequentially supply the pulse of the gate signal to the gate lines 303. The gate driver 320 may output the gate pulse in response to a shift clock received from the timing controller 330 or the display driver 200 through a level shifter.

The timing controller 330 may receive the pixel data of the input image signal and a timing signal synchronized with the pixel data from the host processor 100. The timing controller 330 may transmit the pixel data of the image signal to the data driver 310 and control the operation timings of the display panel driving circuits 310 and 320.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

### INDUSTRIAL APPLICABILITY

The present invention can be applied to a digital high-speed interface between a host processor and a display driver.

1. A transmission and reception control method comprising:
a step in which, in a first mode, a transmission device waits in a non-driving state during a vertical blank period and a reception device transmits an interrupt signal to the transmission device within the vertical blank period;
a step in which, in the first mode, the transmission device wakes up and is synchronized with the reception device when the interrupt signal is detected, and transmits data of an image signal to the reception device together with a synchronization signal; and
a step in which, in a second mode, the transmission device transmits the data of the image signal to the reception device without the synchronization signal and a synchronization signal is generated in the reception device.

2. The transmission and reception control method of claim 1, wherein the transmission device is synchronized with the reception device in a clock and a horizontal period count based on a value obtained by counting the interrupt signal in the first mode.

3. The transmission and reception control method of claim 1, wherein, when a refresh rate of the image signal is lowered, the vertical blank period is extended, and the transmission device waits in the non-driving state within the extended vertical blank period until the interrupt signal is detected.

4. The transmission and reception control method of claim 1, wherein the interrupt signal has a pulse width from 90% to 110% of 1 frame period or comprises an impulse.

5. The transmission and reception control method of claim 1, wherein the first mode is a video mode of a mobile industry processor interface (MIPI),
the second mode is a command mode of the MIPI,
the transmission device comprises one of a system on chip (SoC), an application processor (AP), and a graphics processing unit (GPU), and
the reception device comprises a display driver that outputs the data of the image signal and outputs a display timing signal.

6. A display driver comprising:
an interrupt signal generation part configured to transmit an interrupt signal to a host processor through an interrupt signal line within a vertical blank period in each of a first mode and a second mode;
a reception part configured to receive data of an image signal from the host processor through a data lane together with a synchronization signal in the first mode, and to receive the data of the image signal through the data lane without the synchronization signal in the second mode; and
a display control part configured to generate a display timing signal based on the synchronization signal received from the host processor and outputs the data of the image signal in the first mode, and to generate the display timing signal based on an internally generated synchronization signal and outputs the data of the image signal in the second mode.

7. The display driver of claim 6, wherein, after the interrupt signal is output in the first mode, the data of the image signal is received from the host processor together with the synchronization signal.

8. The display driver of claim 6, wherein, when a refresh rate of the image signal is lowered, the vertical blank period is extended.

9. The display driver of claim 6, wherein the interrupt signal has a pulse width from 90% to 110% of 1 frame period or comprises an impulse.

10. The display driver of claim 6, wherein the first mode is a video mode of a mobile industry processor interface (MIPI), and
the second mode is a command mode of the MIPI.
